(19) United States
(12) Patent Application Publication
(10) Pub. No.: US 2018/0205268 A1
(43) Pub. Date: Jul. 19, 2018

(54) METHOD FOR OPERATING WIRELESS POWER TRANSMISSION DEVICE

(71) Applicant: LG INNOTEK CO., LTD., Seoul (KR)

(72) Inventor: Jay PARK, Seoul (KR)

(73) Assignee: LG INNOTEK CO., LTD., Seoul (KR)

(21) Appl. No.: 15/742,370

(22) PCT Filed: Jun. 28, 2016
(86) PCT No.: PCT/KR2016/006912

§ 371 Date: Jan. 5, 2018

(30) Foreign Application Priority Data
Jul. 6, 2015 (KR) 10-2015-0095810
Jul. 8, 2015 (KR) 10-2015-0096954

(51) Int. Cl. H02J 50/40; H02J 50/12; H02J 50/80; H02J 7/02

(52) U.S. Cl. CPC H02J 50/40; H02J 50/12; H01F 38/14; H02J 7/025; H02J 50/80

(57) ABSTRACT

According to an embodiment of the present invention, there is provided a method of operating a wireless power transfer system-charger including: receiving a unique information RXID from a wireless power transfer system-device, determining a size of the wireless power transfer system-device based on the unique information (RXID), selecting one of a plurality of transmission coils depending on a size of the wireless power transfer system-device.

### TECHNICAL FIELD

The present invention relates to a method of operating a wireless power transmission device.

### BACKGROUND ART

As an information and communication technology is rapidly developing in recent years, a ubiquitous society based on the information and communication technology has been realized. Sensors including computer chips having a communication function embedded therein should be installed in all facilities of the society in order for information and communication devices to be accessible anytime, anywhere. Accordingly, a problem of supplying power to such devices or sensors is becoming a new challenge. In addition, types of mobile devices, such as Bluetooth headsets, music players such as an iPod, and portable phones, are increasing rapidly, thereby requiring a time and an effort for a user to recharge batteries. As a method for solving such a problem, a wireless power transmission technology has attracted attention in recent years.

Wireless power transmission or wireless energy transfer is a technology for wirelessly transmitting electrical energy to a receiver from a transmitter using the induction principles of a magnetic field. In the 1800s, electric motors and transformers using electromagnetic induction principles were already in use, and thereafter, a method of transmitting electrical energy by radiating electromagnetic waves such as radio waves or laser beams has been attempted. Even electric toothbrushes and some cordless razors that we commonly use are actually charged by electromagnetic induction principles.

Until now, a method of wireless energy transfer may be largely classified into a magnetic induction method, an electromagnetic resonance method, and a power transmission method at a short wavelength radio frequency.

The magnetic induction method is commercialized rapidly based on small devices such as mobile phones as a technology using a phenomenon occurring in two coils adjacent to each other, in which a magnetic flux generated when a current is supplied to one coil causes an electromotive force to the other coil. The magnetic induction method may transmit a maximum of several hundred kilowatts (kW) of power, and be highly efficient, but since a maximum transmission distance may be smaller than or equal to 1 centimeter (cm), the magnetic induction method should generally be adjacent to a charger or a floor.

A magnetic-resonance method uses an electric or magnetic field instead of using the electromagnetic waves or current. Since the magnetic-resonance method is hardly influenced by electromagnetic waves, the magnetic-resonance method is safe for other electronic devices or a human body. On the other hand, the magnetic-resonance method may be applicable only at a limited distance and space, and energy transfer efficiency is slightly low.

A short wavelength wireless power transmission method (simply, a radio frequency (RF) method) uses a fact that energy may be transmitted and received directly in a form of radio waves. Such a technology is a wireless power transmission method which is an RF method using a rectenna, and the rectenna is the term of a combination of an antenna and a rectifier, which refers to a device that directly converts RF power into direct current (DC) power. That is, the RF method is a technology that convents an alternating current (AC) radio wave to a DC, studies on commercialization is actively underway with recent improvement in efficiency.

A wireless power transmission technology may be applicable not only to mobile, but also to a wide range of industries such as information technology (IT), railways, and home appliance industries.

In recent years, development of a transmitter applying a combination of a magnetic induction method and a magnetic-resonance method are actively underway. This is because power may be supplied to a reception unit regardless of a type of a power supply method of the reception unit.

Meanwhile, a wireless power transmission device including a plurality of coils is provided depending on various types of wireless power reception devices. However, there is a problem in that a reception device requiring a small amount of power receives a high power and is ruptured.

### Technical Problem

The present invention is directed to providing a wireless power transfer system-device in which a plurality of transmission coils for selectively transmitting power depending on a size of a wireless power transfer system-device are disposed.

The present invention is directed to providing a method of determining, by a wireless power transfer system-device, a wireless power transfer system-device.

### Technical Solution

According to an embodiment of the present invention, there is provided a method of operating a wireless power transfer system-charger including: receiving a unique information (RXID) from a wireless power transfer system-device, determining a size of the wireless power transfer system-device based on the unique information (RXID), selecting one of a plurality of transmission coils depending on a size of the wireless power transfer system-device.

According to another embodiment of the present invention, there is provided a method of operating a wireless power transfer system-charger including: receiving a unique information (RXID) from a wireless power transfer system-device, determining power of the wireless power transfer system-device based on the unique information (RXID), selecting one of a plurality of transmission coils depending on power of the wireless power transfer system-device.

### Advantageous Effects

According to the present invention, a transmission coil is selectively driven depending on a size of a wireless power transfer system-device, thereby improving transfer efficiency.

In addition, the transmission coil is selected to have a high coupling coefficient depending on a size of the wireless power transfer system-device, thereby improving transfer efficiency.

### DESCRIPTION OF DRAWINGS

FIG. 1 is an equivalent circuit of a magnetic induction method.

FIG. 2. is an equivalent circuit of a magnetic resonance method.

FIGS. 3A and 3B are block diagrams illustrating a transmission unit as one of sub-systems constituting a wireless power transfer system.

FIG. 4 is a block diagram illustrating a reception unit as one of sub-systems constituting a wireless power transfer system.

FIG. 5 is a plan view illustrating a transmission coil unit according to an embodiment of the present invention.

FIG. 6 is a plan view illustrating a transmission coil unit according to another embodiment of the present invention.

FIG. 7 is a plan view illustrating a transmission coil unit according to still another embodiment of the present invention.

FIG. 8 is a plan view illustrating a transmission coil unit according to yet another embodiment of the present invention.

FIGS. 9 and 10 are circuit diagrams illustrating a driving unit according to an embodiment of the present invention.

FIG. 11 is a flowchart for describing a method of operating a wireless power transfer system-charger according to an embodiment of the present invention.

FIG. 12 is a flowchart for describing a method of operating a wireless power transfer system-charger according to another embodiment of the present invention.

FIG. 13 is a flowchart for describing a method of operating a wireless power transfer system-charger according to still another embodiment of the present invention.

FIG. 14 is a flowchart for describing a method of operating a wireless power transfer system-charger according to yet another embodiment of the present invention.

### MODES OF THE INVENTION

Hereinafter, according to embodiments of the present invention, a wireless power transfer system including a wireless power transfer system-charger having a function of wirelessly transmitting power and a wireless power transfer system-device of wirelessly receiving power will be described in detail with reference to the drawings. The following embodiments are provided as an example so that a person of ordinary skill in the art may fully understand the spirit of the present invention. Therefore, the present invention is not limited to the embodiments described below, but may be embodied in other forms. In addition, in the drawings, a size and thickness of a device may be exaggerated for convenience. Like reference numerals designate like elements throughout the specification.

The embodiments may include a communication system capable of selectively using various types of frequency bands from low frequency 50 kHz to high frequency 15 MHz for wireless power transmission and exchanging data and control signals for system control.

The embodiments may be applied to various industrial fields using electronic device using or requiring batteries, such as a mobile terminal industry, a smart watch industry, a computer and laptop industry, a home appliance industry, an electric vehicle industry, a medical device industry, a robot industry, or the like.

The embodiments may be in consideration with a system capable of transmitting power to one or a plurality of devices using one or more transmission coils.

According to an embodiment, a battery shortage problem may be solved in mobile devices such as a smart phone, and a laptop computer, and for example, when a wireless charging pad is placed on a table, and a smart phone or laptop is placed thereon, the battery may be charged automatically to use for a long time. In addition, when the wireless charging pad is installed in public places such as cafes, airports, taxis, offices, restaurants, or the like, various mobile devices may be charged regardless of different charging terminals from different mobile device manufacturers. When a wireless power transmission technology is applied to home appliances such as vacuum cleaners, electric fans, or the like, there is no need to find power cables, and complex wires may be eliminated in home, which may reduce wirings in buildings and expand space utilization range. In addition, when an electric vehicle is charged with current household power, long time is required, but when high power is transmitted through the wireless power transmission technology, a charging time may be reduced. In addition, when a wireless charging facility is installed on a parking lot floor, inconvenience of preparing a power cable around the electric vehicle may be solved.

The terms and abbreviations used in the embodiments are as follows.

Wireless Power Transfer System: a system configured to provide wireless power transmission within a magnetic field area.

Wireless Power Transfer System-Charger: a device configured to provide wireless power transmission to a power receiver within a magnetic field area and configured to manage an entire system.

Wireless Power Transfer System-Device: a device configured to be provided with wireless power transmission from a power transmitter within a magnetic field area.

Charging Area: an area where actual wireless power transmission occurs within a magnetic field area, and may vary depending on a size, required power, and operating frequency of application products.

Scattering (S) Parameter: an S parameter is a ratio of an input voltage to an output voltage on a frequency distribution, which is a ratio of an input port to an output port (Transmission; S21) or a self-reflection value of each input/output port, that is, a value of an output reflected back by a self-input (Reflection; S11, S22).

Quality Factor Q: a value Q in resonant refers to quality of frequency selection. The higher the value Q, the better the resonant characteristic. The value Q is represented in a ratio of an energy stored in a resonator to a energy lost.

Looking at the principles of transmitting power wirelessly, there are largely a self-induction method and a self-resonance method in the wireless power transmission principles.

The magnetic induction method is a non-contact energy transfer technology in which an electromotive force is also generated in a load inductor Ll via a generated magnetic flux when a source inductor Ls and a load inductor Ll are brought close to each other to supply a current to one side of the source inductor Ls. In addition, the magnetic-resonance method is a technology of wirelessly transferring energy using a resonant technique, in which magnetic resonant is generated by a natural frequency between the two resonators by combining the two resonators, and electric and magnetic fields are generated in the same wavelength range while vibrating at the same frequency.

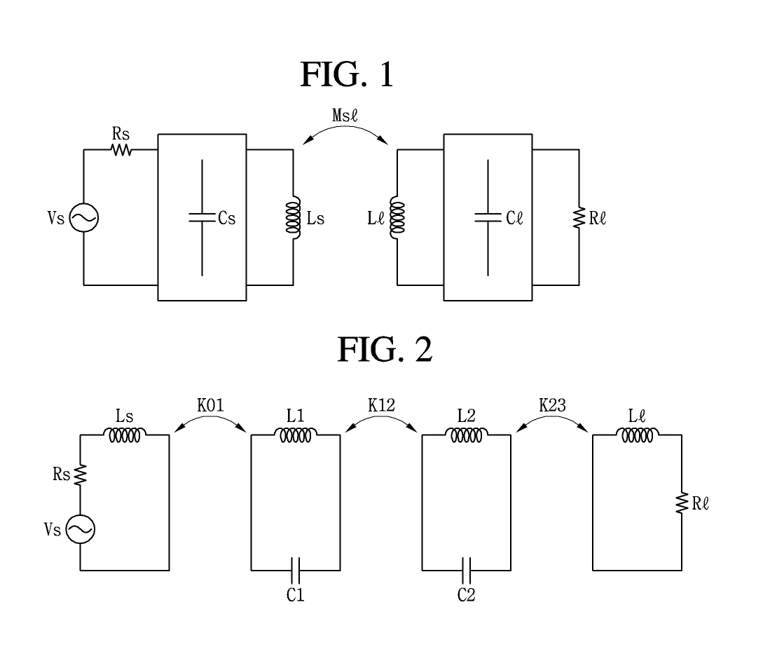

FIG. 1 is an equivalent circuit of a magnetic induction method.

Referring to FIG. 1, in the magnetic induction method equivalent circuit, the wireless power transfer system-device may be implemented with a source voltage Vs and a source resistance Rs according to a power supply device, a source capacitor Cs for impedance matching, and a source coil Ls for a magnetic coupling with the wireless power transfer system-device. The wireless power transfer system-device may be implemented with a load resistance Rl which is an equivalent resistance of a wireless power transfer system-device, a load capacitor Cl for impedance matching, and a load coil Ll for a magnetic coupling with the wireless power transfer system-charger. A degree of the magnetic coupling between the source coil Ls and the load coil Ll may be represented in mutual inductance Msl.

In FIG. 1, when a ratio S21 of an input voltage to an output voltage is obtained from the magnetic induction equivalent circuit consisting of only the coil without the source capacitor Cs and the load capacitor Cl for impedance matching and a maximum power transmission condition is obtained from the ratio S21, a maximum power transmission condition satisfies the following Equation 1.

Ls/Rs=Ll/Rl [Equation 1]

When the ratio of the inductance of the transmission coil Ls to the source resistance Rs is equal to the ratio of the inductance of the load coil Ll and the load resistance Rl, a maximum power transmission may be performed. Since there is no capacitor capable of compensating for reactance in a system in which there is only an inductance, a value of a self-reflection value S11 of input and output ports may not be zero at the point when a maximum power is transmitted, and the power transfer efficiency may vary greatly depending on a mutual inductance value. Therefore, the source capacitor Cs may be added to the wireless power transfer system-charger, and the load capacitor Cl may be added to the wireless power transfer system-device as the compensation capacitor for impedance matching. The compensation capacitors Cs and Cl may be connected in series or in parallel to the reception coil Ls and the load coil Ll, respectively. For the impedance matching, the compensation capacitors as well as a passive device such as additional capacitor and an inductor may be added in each of the wireless power transfer system-charger and the wireless power transfer system-device.

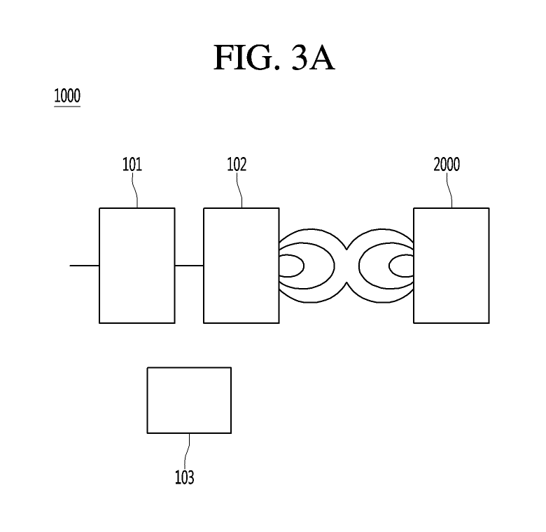

FIG. 2 is an equivalent circuit of a magnetic resonance method.

Referring to FIG. 2, in the magnetic resonant equivalent circuit, the wireless power transfer system-charger is implemented with a source coil constituting a closed circuit including a source voltage Vs, a source resistance Rs, and a source inductor Ls which are connected in series, and a transmission-side resonant coil constituting a closed circuit including a transmission-side resonant inductor L1 and transmission-side resonant capacitor C1 which are connected in series. The wireless power transfer system-device is implemented with a load coil constituting the closed circuit in a load resistance Rl and a load inductor Ll which are connected in series, and a reception-side resonant coil constituting a closed circuit including a reception-side resonant inductor L2 and a reception-side resonant capacitor C2 which are connected in series. The source inductor Ls and the transmission-side inductor L1 are magnetically coupled to the coupling coefficient of K01. The load inductor Ll and the load-side resonant inductor L2 are magnetically coupled to the coupling coefficient of K23. The transmission-side resonant inductor L1 and the reception-side resonant inductor L2 are magnetically coupled to the coupling coefficient of L12. In an equivalent circuit of another embodiment, the source coil and/or the load coil may be omitted, and only the transmission-side resonant coil and the reception-side resonant coil may be included.

When the resonant frequencies of the two resonators are the same, the magnetic-resonance method may transfer most energy in the resonator of the wireless power transfer system-charger to the resonator of the wireless power transfer system-device, and thus power transmission efficiency can be improved. The efficiency in the magnetic-resonance method may be improved when the following Equation 2 is satisfied.

k/Γ>>1(k is a coupling coefficient, and Γ is an attenuation rate) [Equation 2]

In order to increase the efficiency in the magnetic-resonance method, a device for impedance matching may be added, and the impedance matching device may be a passive device such as an inductor and a capacitor.

A wireless power transfer system for transmitting power by the magnetic induction method or the magnetic-resonance method will be described based on the principles of the above-described wireless power transmission.

### <Wireless Power Transfer System-Charger>

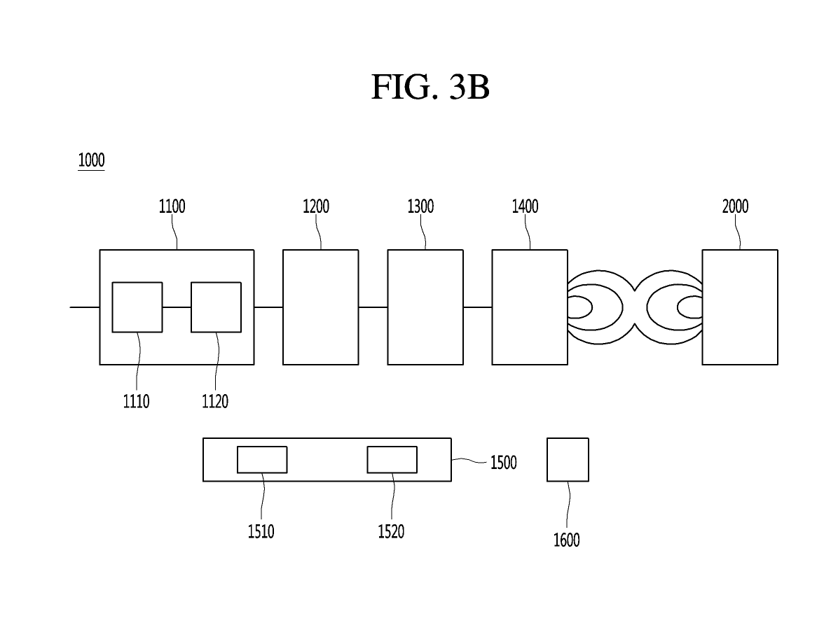

FIGS. 3A and 3B are block diagrams illustrating a wireless power transfer system-charger as one of the sub-systems constituting the wireless power transfer system.

Referring to FIG. 3A, according to an embodiment, a wireless power transfer system may include a wireless power transfer system-charger 1000 and a wireless power transfer system-device 2000 receiving wireless power from the wireless power transfer system-charger 1000. The wireless power transfer system-charger 1000 may include: a power conversion unit 101 configured to convert power of an input AC signal and to output the power as an AC signal; a resonant circuit unit 102 configured to generate magnetic fields based on the AC signal output from the power conversion unit 101 and to provide the power to the wireless power transfer system-device 2000 in a charging area; a control unit 103 capable of controlling power conversion of the power conversion unit 101, adjusting an amplitude and frequency of an output signal of the power conversion unit 101, performing impedance matching of the resonant circuit unit 102, sensing impedance, voltage, and current information from the power conversion unit 101 and the resonant circuit unit 102, and wirelessly communicating with the wireless power transfer system-device 2000. The power conversion unit 101 may include at least one of a power conversion unit configured to convert an alternating current (AC) signal into a direct current (DC) signal, a power conversion unit configured to change a level of a DC and to output the DC, and a power conversion unit configured to convert a DC into an AC. In addition, the resonant circuit unit 102 may include a coil and an impedance matching unit capable of resonating with the coil. Further, the control unit 103 may include a sensing unit configure to sense impedance, voltage, and current information, and a wireless communication unit.

In detail, referring to FIG. 3B, the wireless power transfer system-charger 1000 may include a transmission-side AC/DC conversion unit 1100, a transmission-side DC/AC conversion unit 1200, a transmission-side impedance matching unit 1300, a transmission coil unit 1400, and a control unit 1500.

The transmission-side AC/DC conversion unit 1100 is a power conversion unit that converts an AC signal provided from the outside into a DC signal under the control of the transmission-side convert communication and control unit 1500, and thus the transmission-side AC/DC conversion unit 1100 may include a rectifier 1110 and a transmission-side DC/DC conversion unit 1120 as a sub-system. The rectifier 1110 may be a system of converting a provided AC signal into a DC signal, and thus, may be a diode rectifier having a relatively high efficiency, a synchronous rectifier capable of being one-chip, or a hybrid rectifier capable of saving costs and space, and may be a hybrid rectifier having a high degree of freedom in dead time, when operated at a high frequency according to an embodiment. However, the embodiment is not limited thereto and is applicable to a system that converts an AC to a DC. The transmission-side DC/DC conversion unit 1120 controls a level of the DC signal provided from the rectifier 1110 under the control of the transmission-side communication and control unit 1500, and thus, may be a buck converter configured to lower the level of the input signal, a boost converter configured to boost the level of the input signal, a buck boost converter capable of lowering or increasing a level of an input signal, or Cuk converter as an exemplary embodiment. In addition, the transmission-side DC/DC conversion unit 1120 may include a switch device configured to perform a power conversion control function, an inductor and a capacitor configured to perform a power conversion mediation function or an output voltage smoothing function, a transformer configured to perform a voltage gain control function or an electrical separation function (insulation function) or the like, and may perform a function to remove a ripple factor or a pulse factor (AC factor included in the DC signal) included in the input DC signal. An error between a command value and an actual output value of the output signal of the transmission-side DC/DC conversion unit 1120 may be adjusted via a feedback method, which may be performed by the transmission-side communication and control unit 1500.

The transmission-side DC/AC conversion unit 1200 may be a system capable of converting the DC signal output from the transmission-side AC/DC conversion unit 1100 into the AC signal under the control of the transmission-side communication and control unit 1500, and outputting the converted AC signal frequency, and thus there are a half bridge inverter or a full bridge inverter as an exemplary embodiment. In addition, the wireless power transfer system may be applied to various amplifiers that convert a DC to an AC, for example, there are Class A, Class B, Class AB, Class C, Class E, or Class F amplifiers. Further, the transmission-side DC/AC conversion unit 1200 may include an oscillator configured to generate a frequency of an output signal and a power amplification unit configured to amplify an output signal.

The transmission-side impedance matching unit 1300 minimizes the reflected waves at a point having a different impedance to improve a signal flow. Since the two coils of the wireless power transfer system-charger 1000 and the wireless power transfer system-device 2000 may be spatially separated, and a leakage of the magnetic field may be large, and the impedance difference between the two connection ends of the wireless power transfer system-charger 1000 and the wireless power transfer system-device 2000 may be corrected, thereby improving power transfer efficiency. The transmission-side impedance matching unit 1300 may include an inductor, a capacitor, and a resistor, and may adjust the impedance value for impedance matching by changing the inductance of the inductor, the capacitance of the capacitor, and the resistance value of the resistance under the control of the communication and control unit 1500. When the wireless power transfer system transmits power in the magnetic induction method, the transmission-side impedance matching unit 1300 may have a series resonant structure or a parallel resonant structure, and may increase the inductance coupling coefficient between the wireless power transfer system-charger 1000 and the wireless power transfer system-device 2000, thereby minimizing energy loss. When the wireless power transfer system transmits power in a magnetic resonance method, the transmission-side impedance matching unit 1300 may make real-time correction of impedance matching depending on a change in the matching impedance on the energy transfer line due to a change in characteristic of the coil, which is caused by changing the separation distance between the wireless power transfer system-charger 1000 and the wireless power transfer system-device 2000, or metallic foreign object (FO), mutual influence by multiple devices, or the like. Accordingly, the correction method may be a multi-matching method using a capacitor, a matching method using a multi-antenna, or a method using a multi-loop.

The transmission-side coil 1400 may be embodied in a plurality of coils or a single coil. When the plurality of transmission-side coils 1400 are provided, the transmission-side coils 1400 may be disposed to be spaced apart from each other, or disposed to overlap each other. When the transmission-side coils 1400 are disposed to overlap, the overlapping area may be determined in consideration of a deviation of a magnetic flux density. In addition, when the transmission-side coil 1400 is manufactured, the transmission-side coil 1400 may be manufactured in consideration of an internal resistance and a radiation resistance. In this case, when a resistance factor is small, a quality factor may be increased, and the transfer efficiency may be increased.

The communication and control unit 1500 may include a transmission-side control unit 1510 and a transmission-side communication unit 1520. The transmission-side control unit 1510 may function to control an output voltage of the transmission-side AC/DC conversion unit 1100 in consideration of a power demand of the wireless power transfer system-device 2000, a current charging amount, and a wireless power method. In addition, the transmission-side control unit 1510 may generate frequencies and switching waveforms for driving the transmission-side DC/AC conversion unit 1200 in consideration of maximum power transfer efficiency, and may control a power to be transmitted. Further, the transmission-side control unit 1510 may determine a size of the wireless power transfer system-device based on the unique information RXID received from the wireless power transfer system-device. That is, one of a plurality of transmission coils may be selected according to the size of the wireless power transfer system-device. The unique information RXID may include an RXID message, a certification version, identification information, and an cyclic redundancy check (CRC), but is not limited thereto. The RXID message may include size and power information of the wireless power transfer system-device.

In addition, the transmission-side control unit 1510 may control an entire operation of the wireless power transfer system-device 2000 using an algorithm, a program, or an application required for a control read from a storage unit (not shown) of the wireless power transfer system-device 2000. Meanwhile, the transmission-side control unit 1510 may be referred to as a microprocessor, a micro controller unit, or a micom. The transmission-side communication unit 1520 may perform communication with a reception side communication unit 2620, and may use a short-range communication method such as Bluetooth, near field communication (NFC), ZigBee, or the like as one example of a communication method. The transmission-side communication unit 1520 and the reception side communication unit 2620 may transmit and receive charging status information, a charging control command or the like to each other. In addition, the charging status information may include the number of the wireless power transfer system-devices 2000, a battery remaining amount, a charging cycle, an usage amount, a battery capacity, a battery ratio, and a transmission power amount of the wireless power transfer system-charger 1000. Further, the transmission-side communication unit 1520 may transmit a charging function control signal for controlling the charging function of the wireless power transfer system-device 2000, and the charging function control signal may be a control signal of controlling the wireless power transfer system-device 2000 to be enabled or disabled charging function.

As described above, the transmission-side communication unit 1520 may communicate using an out-of-band format configured with separate modules, but is not limited thereto. The transmission-side communication unit 1520 may perform communication using an in-band format using a feedback signal transmitted from the wireless power transfer system-device to the wireless power transfer system-charger using the power signal transmitted from the wireless power transfer system-charger. For example, the wireless power transfer system-device may modulate a feedback signal to transmit information such as a start of charging, an end of charging, a battery state, or the like to the transmitter through a feedback signal. The transmission-side communication unit 1520 may be provided separately from the transmission-side control unit 1510, and the wireless power transfer system-device 2000 may also be included in a control unit 2610 of an receiving apparatus or may be provided separately.

### <Wireless Power Transfer System-Device>

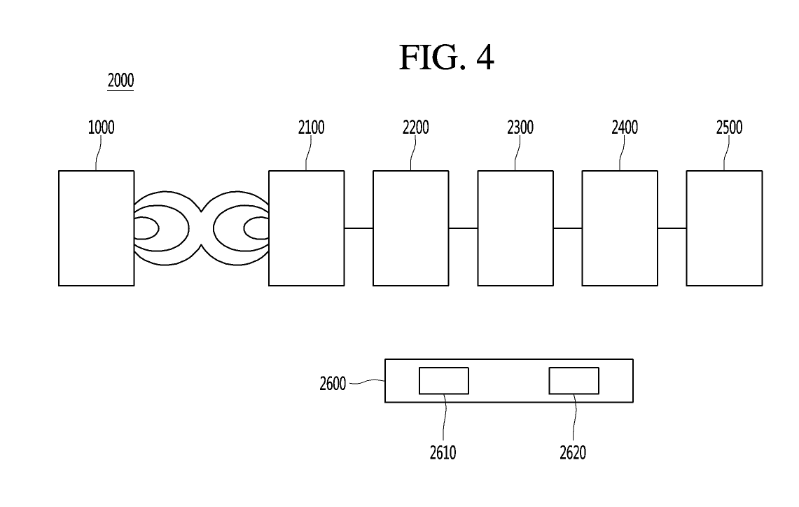

FIG. 4 is a block diagram illustrating a wireless power transfer system-device as one of sub-systems configuring a wireless power transfer system.

Referring to FIG. 4, the wireless power transfer system may include a wireless power transfer system-charger 1000 and a wireless power transfer system-device 2000 receiving wireless power from the wireless power transfer system-charger 1000, and the wireless power transfer system-device 2000 may include a reception-side coil unit 2100, a reception-side impedance matching unit 2200, a reception-side AC/DC conversion unit 2300, a reception-side DC/DC conversion unit 2400, a load 2500, and a reception-side communication and control unit 2600.

The reception-side coil unit 2100 may receive power through a magnetic induction method or a magnetic resonance method. As described above, the reception-side coil unit 2100 may include at least one of an induction coil and a resonant coil depending on a power reception method. The reception-side coil unit 2100 may be provided with an NFC antenna. The reception-side coil unit 2100 may be the same as the transmission-side coil unit 1400, and a dimension of a reception antenna may be different depending on an electrical characteristic of the wireless power transfer system-device 2000.

The reception-side impedance matching unit 2200 performs impedance matching between the wireless power transfer system-charger 1000 and the wireless power transfer system-device 2000.

The reception-side AC/DC conversion unit 2300 rectifies an AC signal output from the reception-side coil unit 2100 to generate a DC signal.

The reception-side DC/DC conversion unit 2400 may adjust a level of a DC signal output from the reception-side AC/DC conversion unit 2300 to a capacity of the load 2500.

The load 2500 may include a battery, a display, a sound output circuit, a main processor, and various sensors.

The reception-side communication and control unit 2600 may be activated by wake-up power from the transmission-side communication and control unit 1500, may perform communication with the transmission-side communication and control unit 1500, and may control operation of the sub-system of the wireless power transfer system-device 2000.

The wireless power transfer system-device 2000 may be provided with a single or a plurality of wireless power transfer system-chargers 1000 and may simultaneously receive energy from the wireless power transfer system-chargers 1000. That is, a plurality of target wireless power transfer system-devices 2000 may receive power from one wireless power transfer system-charger 1000 in the wireless power transfer system of the magnetic resonance method. In this case, the transmission-side matching unit 1300 of the wireless power transfer system-charger 1000 may adaptively perform impedance matching between the plurality of wireless power transfer system-devices 2000, which may be equally applied to the case in which a plurality of reception-side coil units, which are independent each other, in the magnetic induction method are provided.

In addition, when the wireless power transfer system-devices 2000 are provided with the plurality of wireless power transfer system-devices 2000, the systems may use the same power reception method or may be different systems. In this case, the wireless power transfer system-charger 1000 may be a system that transmits power by the magnetic induction method or the magnetic induction method, or a combination system using both methods.

Meanwhile, looking at a relationship between a size and frequency of a signal of the wireless power transfer system, in the case of the wireless power transfer system of the magnetic induction method, in the wireless power transfer system-charger 1000, the transmission-side AC/DC conversion unit 1100 may receive an AC signal of tens or hundreds of Hz band (for example, 60 Hz) of tens or hundreds of V band (for example, 110 V to 220 V) and output by converting to a DC signal in several or tens or hundreds of voltage band (for example, 10 V to 20 V), and the transmission-side DC/AC conversion unit 1200 may receive an DC signal and output an AC signal of a KHz band (for example, 125 KHz). Further, the reception-side AC/DC conversion unit 2300 of the wireless power transfer system-device 2000 may receive an AC signal in a KHz band (for example, 125 KHz) and output by converting to a DC signal in several or tens or hundreds of voltage band (for example, 10 to 20 V). The reception-side DC/DC conversion unit 2400 may output a DC signal of, for example, 5V suitable for the load 2500 and transmit the DC signal to the load 2500. Furthermore, in the case of the wireless power transfer system of the magnetic resonance method, in the wireless power transfer system-charger 1000, the transmission-side AC/DC conversion unit 1100 may receive an AC signal in tens or hundreds of Hz band (for example, 60 Hz) of tens or hundreds of voltage band (for example, 110 V to 220 V) and output by converting to a DC signal in several or tens or hundreds of voltage band (for example, 10 V to 20 V), and the transmission-side DC/AC conversion unit 1200 may receive an DC signal and output an AC signal in a MHz band (for example, 6.78 MHz). In addition, the reception-side AC/DC conversion unit 2300 of the wireless power transfer system-device 2000 may receive an AC signal in a MHz band (for example, 6.78 MHz) and output by converting to an reception-side DC signal in several or tens or hundreds of voltage band (for example, 10 V to 20 V). The DC/DC conversion unit 2400 may output a DC signal of, for example, 5 V suitable for the load 2500 and transmit the DC signal to the load 2500.

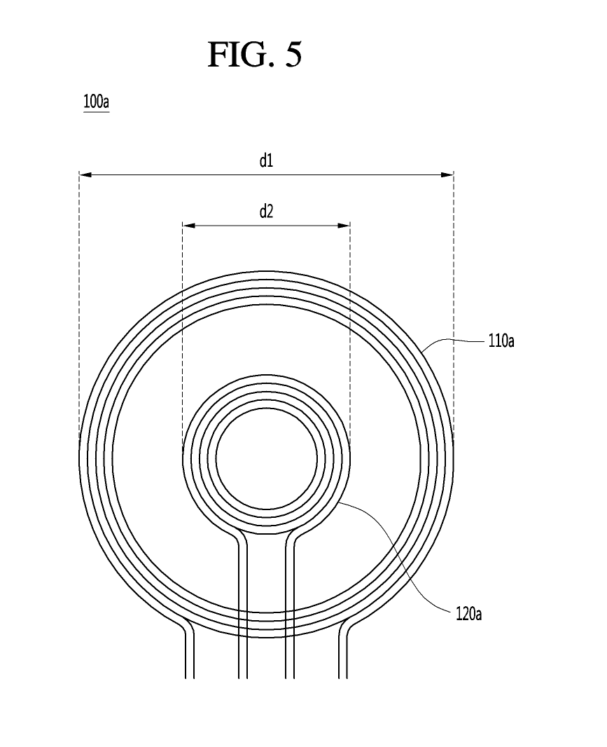

FIG. 5 is a plan view illustrating a transmission coil unit according to an embodiment of the present invention.

Referring to FIG. 5, the transmission coil unit 1400 of FIG. 4 may be implemented as a transmission coil unit 100a including a plurality of transmission coils, and the transmission coil unit 100a may include a first transmission coil 110a and a second transmission coil 120a disposed inside of the first transmission coil 110a.

The first transmission coil 110a and the second transmission coil 120a substantially transmit power in the wireless power transfer system-charger 1000. In this case, the first transmission coil 110a and the second transmission coil 120a may include at least one of a transfer induction coil and a transfer resonant coil depending on a charging method. The first transmission coil 110a and the second transmission coil 120a are formed to have a space in a central region. Here, the first transmission coil 110a and the second transmission coil 120a may be lead wires wound several times. For example, the first transmission coil 110a and the second transmission coil 120a may be formed in a helical type or a spiral type. In addition, the first transmission coil 110a and the second transmission coil 120a may be formed in a circular or rectangular shape. Further, the lead wire may be made of a conductive material and coated with an insulating material.

The transmission-side control unit 1510 may determine a size of the wireless power transfer system-device 2000 based on a unique information RXID received from the wireless power transfer system-device. That is, one of the plurality of transmission coils may be selected depending on a size of the wireless power transfer system-device 2000. For example, when a size of the wireless power transfer system-device 2000 is greater than that of the reference value, the first transmission coil may operate. When a size of the wireless power transfer system-device 2000 is smaller than that of the reference value, the second transmission coil may operate. The reference value may be an average value of diameters of the plurality of transmission coils, but is not limited thereto.

The first transmission coil 110a and the second transmission coil 120a may be in a circle shape, a diameter d1 of the first transmission coil 110a may be 54 mm or more and 56 mm or less, and a diameter d2 of the second transmission coil 120a may be 29 mm or more and 31 mm or less, but is not limited thereto.

The center of the first transmission coil 110a and the center of the second transmission coil 120a may correspond to each other, but the present invention is not limited thereto.

The first transmission coil 110a and the second transmission coil 120a may have the same charging method. According to an embodiment, the first transmission coil 110a and the second transmission coil 120a may have different charging methods.

That is, according to an embodiment of the present invention, when the wireless power transfer system-device 2000 is identified, the wireless power transfer system-charger 1000 may selectively drive the first transmission coil 110a and the second transmission coil 120a depending on a size of the coil of the wireless power transfer system-device 2000, and thus transfer efficiency of the wireless power transfer system-charger is improved. In this case, the size of the coil of the wireless power transfer system-device 2000 may be calculated by analyzing unique information received from the wireless power transfer system-device 2000.

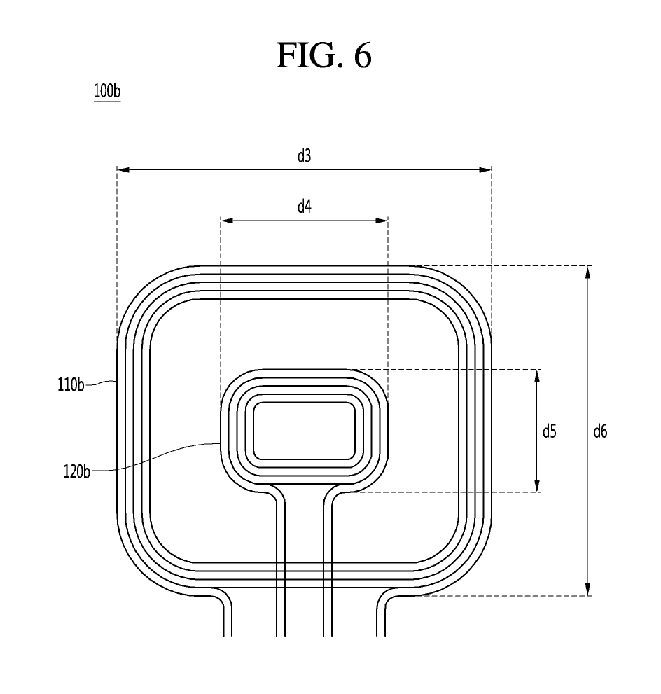

FIG. 6 is a plan view illustrating a transmission coil unit according to another embodiment of the present invention.

Referring to FIG. 6, the transmission coil unit 1400 of FIG. 4 may be implemented as a transmission coil unit 100b including a plurality of transmission coils, and the transmission coil unit 100b may include a first transmission coil 110b and a second transmission coil 120b disposed inside of the first transmission coil 110b.

The first transmission coil 110b and the second transmission coil 120b may be in an elliptical shape, a horizontal width d3 of the first transmission coil 110b is 54 mm or more and 56 mm or less, a vertical width d6 thereof is 47 mm, a horizontal width d4 of the second transmission coil 120b is 29 mm or more and 31 mm or less, and a vertical width d5 thereof is 19 mm or more and 21 mm or less, but is not limited thereto.

The center of the first transmission coil 110b and the center of the second transmission coil 120b may correspond to each other, but the present invention is not limited thereto.

The first transmission coil 110b and the second transmission coil 120b may have the same charging method. According to an embodiment the first transmission coil 110b and the second transmission coil 120b may have different charging methods.

That is, according to an embodiment of the present invention, when the wireless power transfer system-device 2000 is detected, the wireless power transfer system-charger 1000 selectively drives the first transmission coil 110b and the second transmission coil 120b depending on a size of the coil of the wireless power transfer system-device 2000, and thus transfer efficiency of the wireless power transfer system-charger is improved. In this case, the size of the coil of the wireless power transfer system-device 2000 may be calculated by analyzing unique information received from the wireless power transfer system-device 2000.

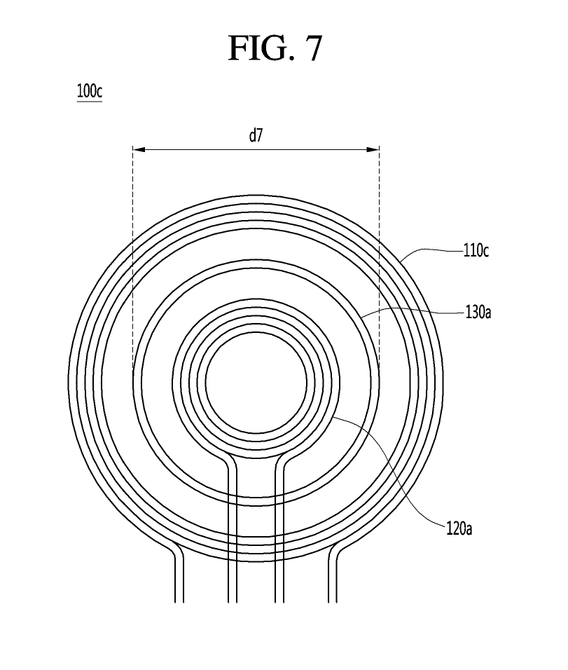

FIG. 7 is a plan view illustrating a transmission coil unit according to still another embodiment of the present invention.

Referring to FIG. 7, the transmission coil unit 1400 of FIG. 4 may be implemented as a transmission coil unit 100c including a plurality of transmission coils, and the transmission coil unit 100c may include a first transmission coil 110b, a second transmission coil 120b disposed inside the first transmission coil 110b, and a shield unit 130a between the first transmission coil 110b and the second transmission coil 120c.

The first transmission coil 110c and the second transmission coil 120c may be in a circle shape, a diameter of the first transmission coil 110c is 54 mm or more and 56 mm or less, a diameter of the second transmission coil 120c is 29 mm or more and 31 mm or less, and a diameter of the shield unit 130a may be 41 mm or more and 43 mm or less, but the present invention is not limited thereto.

The center of the first transmission coil 110c and the center of the second transmission coil 120c may correspond to each other, but the present invention is not limited thereto.

The first transmission coil 110c and the second transmission coil 120c may have the same charging method. According to an embodiment the first transmission coil 110c and the second transmission coil 120c may have different charging methods.

That is, according to an embodiment of the present invention, when the wireless power transfer system-device 2000 is detected, the wireless power transfer system-charger 1000 selectively drives the first transmission coil 110c and the second transmission coil 120c depending on a size of the coil of the wireless power transfer system-device 2000, and thus transfer efficiency of the wireless power transfer system-charger is improved. In this case, the size of the coil of the wireless power transfer system-device 2000 may be calculated by analyzing unique information received from the wireless power transfer system-device 2000.

In addition, in an embodiment, the shield unit 130a may change a transfer path of some of the magnetic fields generated in the first transmission coil 110c and the second transmission coil 120c. The shield unit 130a may include a magnetic material of a different type and for example, may include a spinel type, a hexa type, a sandust type, a fermalloy type magnetic material, but is not limited thereto. That is, the shield unit 130a is disposed between the first transmission coil 110c and the second transmission coil 120c to prevent interference between the transmission coils, and thus the transmission coil unit 100c can improve transfer efficiency.

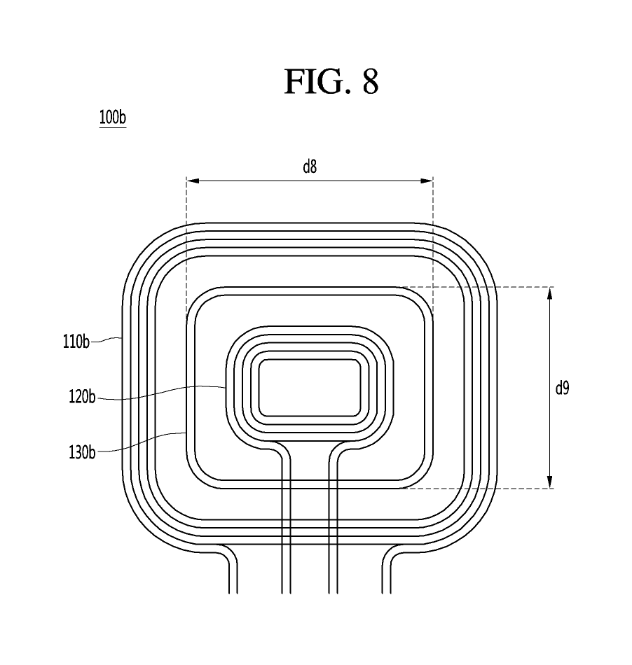

FIG. 8 is a plan view illustrating a transmission coil unit according to yet another embodiment of the present invention.

Referring to FIG. 8, the transmission coil unit 1400 of FIG. 4 may be implemented as a transmission coil unit 100d including a plurality of transmission coils, and the transmission coil unit 100d may include a first transmission coil 110d, a second transmission coil 120d disposed inside the first transmission coil 110d, and a shield unit 130b between the first transmission coil 110d and the second transmission coil 120d.

The first transmission coil 110d and the second transmission coil 120d may be in an elliptical shape, the horizontal width of the first transmission coil 110d is 54 mm or more and 56 mm or less, the vertical width thereof is 47 mm, the horizontal width of the second transmission coil 120d is 29 mm or more and 31 mm or less, and the vertical width thereof is 19 mm or more and 21 mm or less, but is not limited thereto.

The center of the first transmission coil 110d and the center of the second transmission coil 120d may correspond to each other, but the present invention is not limited thereto.

The first transmission coil 110d and the second transmission coil 120d may have the same charging method. According to an embodiment the first transmission coil 110d and the second transmission coil 120d may have different charging methods.

That is, according to an embodiment of the present invention, when the wireless power transfer system-device 2000 is detected, the wireless power transfer system-charger 1000 selectively drives the first transmission coil 110d and the second transmission coil 120d depending on a size of the coil of the wireless power transfer system-device 2000, and thus transfer efficiency of the wireless power transfer system-charger is improved. In this case, the size of the coil of the wireless power transfer system-device 2000 may be calculated by analyzing unique information received from the wireless power transfer system-device 2000.

In addition, in an embodiment, the shield unit 130b may change a transfer path of some of the magnetic fields generated in the first transmission coil 110d and the second transmission coil 120d. The shield unit 130b may include a magnetic material in a different type and for example, may include a spinel type, a hexa type, a sandust type, a fermalloy type magnetic material, but is not limited thereto. That is, the shield unit 130b is disposed between the first transmission coil 110d and the second transmission coil 120d to prevent interference between the transmission coils, and thus the transmission coil unit 100d can improve transfer efficiency.

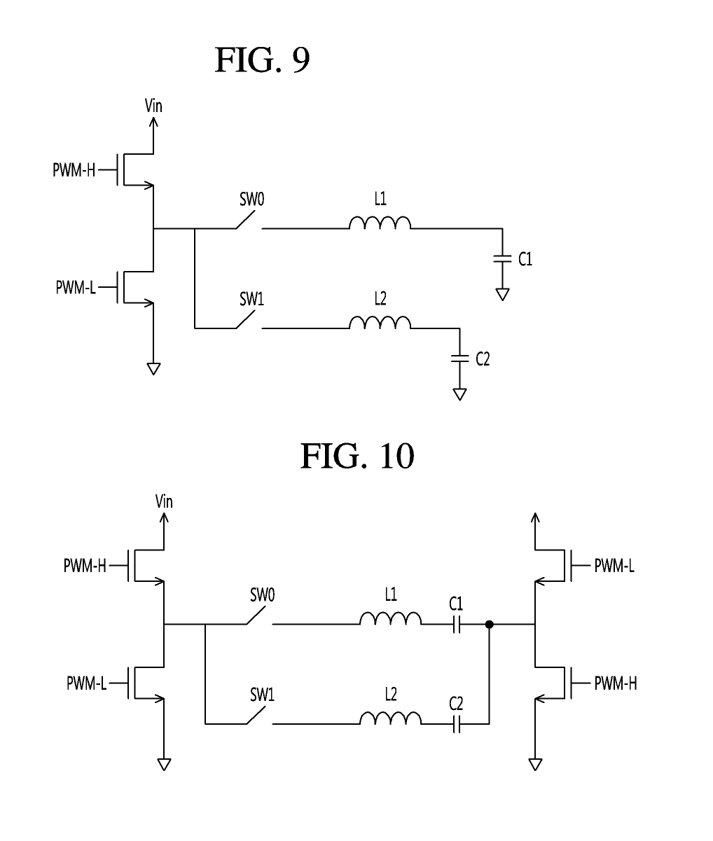

FIGS. 9 and 10 are circuit diagrams illustrating a driving unit according to an embodiment of the present invention.

Referring to FIG. 9, when the transmission-side DC/AC conversion unit 1200 of FIG. 4 is implemented as a half bridge inverter, and the power is higher than or equal to the reference power, or a size of the wireless power transfer system-device 2000 is greater than the reference value according to a unique information RXID received in the wireless power transfer system-devices 2000, a switch SW0 is turned on to operate an inductor L1. When the power is lower than a reference power, or a size of the wireless power transfer system-device 2000 is smaller than the reference value according to a unique information RXID received from the wireless power transfer system-device 2000, a switch SW1 may be turned on to operate an inductor L2. The capacitors C1 and C2 may be operated to perform impedance matching. For example, in an embodiment, the reference power may be 5 W, but is not limited thereto.

The reference value may be an average value of diameters of the plurality of transmission coils, and the reference power may be 5 W, but is not limited thereto.

That is, the inductor L1 may be the first transmission coil 110a, 110b, 110c, or 110d of FIGS. 5 to 8, and the inductor L2 may be the second transmission coil 120a, 120b, 120c, and 120d.

Referring to FIG. 10, when the transmission-side DC/AC conversion unit 1200 of FIG. 4 is implemented as a full bridge inverter, and the power is higher than or equal to the reference power, or a size of the wireless power transfer system-device 2000 is greater than the reference value according to a unique information RXID received in the wireless power transfer system-device 2000, a switch SW0 is turned on to operate an inductor L1. When the power is lower than or equal to a reference power, or a size of the wireless power transfer system-device 2000 is smaller than the reference value according to a unique information RXID received from the wireless power transfer system-device 2000, the switch SW1 may be turned on to operate an inductor L2. Capacitors C1 and C2 may be used to perform impedance matching. For example, in an embodiment, the reference power may be 5 W, but is not limited thereto.

That is, the inductor L1 may be the first transmission coil 110a, 110b, 110c, or 110d of FIGS. 5 to 8, and the inductor L2 may be the second transmission coil 120a, 120b, 120c, and 120d.

According to the embodiment, when the power is higher than the reference power or a size of the wireless power transfer system-device 2000 is higher than or equal to the reference value, according to a unique information RXID received from the wireless power transfer system-device 2000, the full bridge inverter of FIG. 10 may be driven. When the power is lower than or equal to the reference power according to a unique information RXID received from the wireless power transfer system-device 2000, or a size of the wireless power transfer system-device 2000 is smaller than the reference value, the half bridge inverter of FIG. 9, may be operated, but is not limited thereto. The reference value may be an average value of diameters of the plurality of transmission coils, and the reference power may be 5 W, but is not limited thereto.

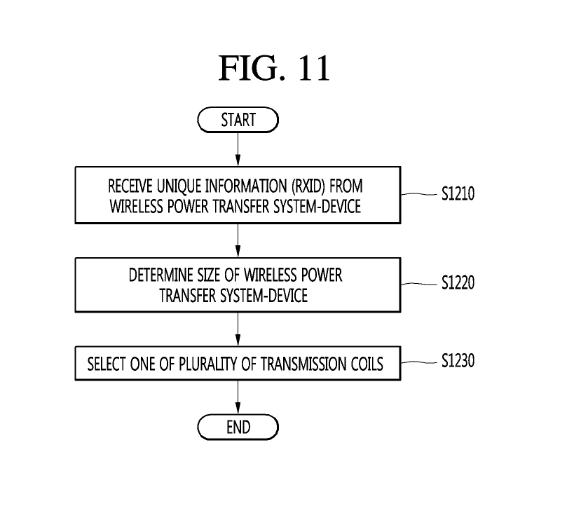

FIG. 11 is a flowchart for describing a method of operating a wireless power transfer system-charger according to an embodiment of the present invention.

Referring to FIG. 11, the wireless power transfer system-charger 1000 may receive a unique information RXID from the wireless power transfer system-device 2000 in operation S1210.

The wireless power transfer system-charger 1000 may determine a size of the wireless power transfer system-device 2000 based on a unique information RXID in operation S1220. The unique information RXID may include an RXID message, a certification version, identification information, and an cyclic redundancy check (CRC), but is not limited thereto. The RXID message may include size and power information of the wireless power transfer system-device.

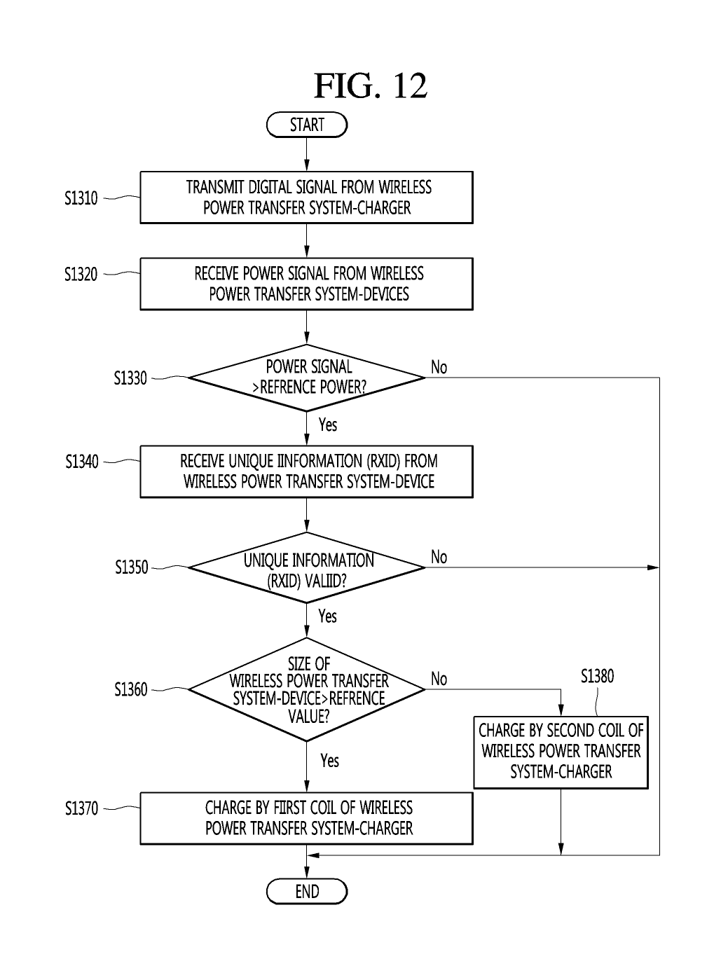

The wireless power transfer system-charger 1000 may transmit power by selecting one of a plurality of transmission coils corresponding to a size of the wireless power transfer system-device 2000 in operation S1230. A concrete method of operating the wireless power transfer system-charger 1000 will be described in detail with reference to FIG. 12.

FIG. 12 is a flowchart for describing a method of operating a wireless power transfer system-charger according to another embodiment of the present invention.

Referring to FIG. 12, the wireless power transfer system-charger 1000 may transmit an analog signal in a standby state. When the wireless power transfer system-device 2000 is searched for, the wireless power transfer system-charger 1000 transmits a digital signal to the wireless power transfer system-device 2000 in operation S1310. A frequency of a digital signal may be 285 kHz or more and 315 kHz or less. For example, the wireless power transfer system-charger 1000 may transmit five times or less of digital signals for a time period of 28 ms or less. When there is no response from the wireless power transfer system-device 2000, the wireless power transfer system-charger 1000 may return to the standby state.

The wireless power transfer system-charger 1000 may receive a power signal from the wireless power transfer system-device 2000 in operation S1320. A frequency of the power signal may be 215 kHz or more and 220 kHz or less, but is not limited thereto.

When a power signal received from the wireless power transfer system-device 2000 is valid in operation S1330, the wireless power transfer system-charger 1000 may receive a unique information RXID of the wireless power transfer system-device 2000 in operation S1340.

The wireless power transfer system-charger 1000 determines whether a unique information RXID is valid in operation S1350. When the unique information RXID is valid, a size of the wireless power transfer system-device 2000 may be determined based on the unique information RXID. The determined and received size of the wireless power transfer system-device 2000 may be compared with the reference value in operation S1360. The reference value may be an average value of diameters of the plurality of transmission coils, but is not limited thereto.

When the size of the wireless power transfer system-device 2000 is greater than the reference value, the wireless power transfer system-charger 1000 may select the first transmission coil to transmit the power in operation S1370. When the size of the wireless power transfer system-device 2000 is smaller than the reference value, the wireless power transfer system-charger 1000 may select the second transmission coil to transmit the power in operation S1380.

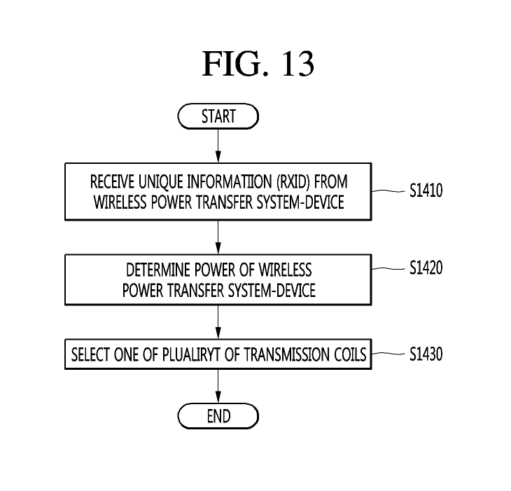

FIG. 13 is a flowchart for describing a method of operating a wireless power transfer system-charger according to still another embodiment of the present invention.

Referring to FIG. 13, the wireless power transfer system-charger 1000 may receive a unique information RXID from the wireless power transfer system-device 2000 in operation S1410. The unique information RXID may include an RXID message, a certification version, identification information, and an cyclic redundancy check (CRC), but is not limited thereto. The RXID message may include size and power information of the wireless power transfer system-device.

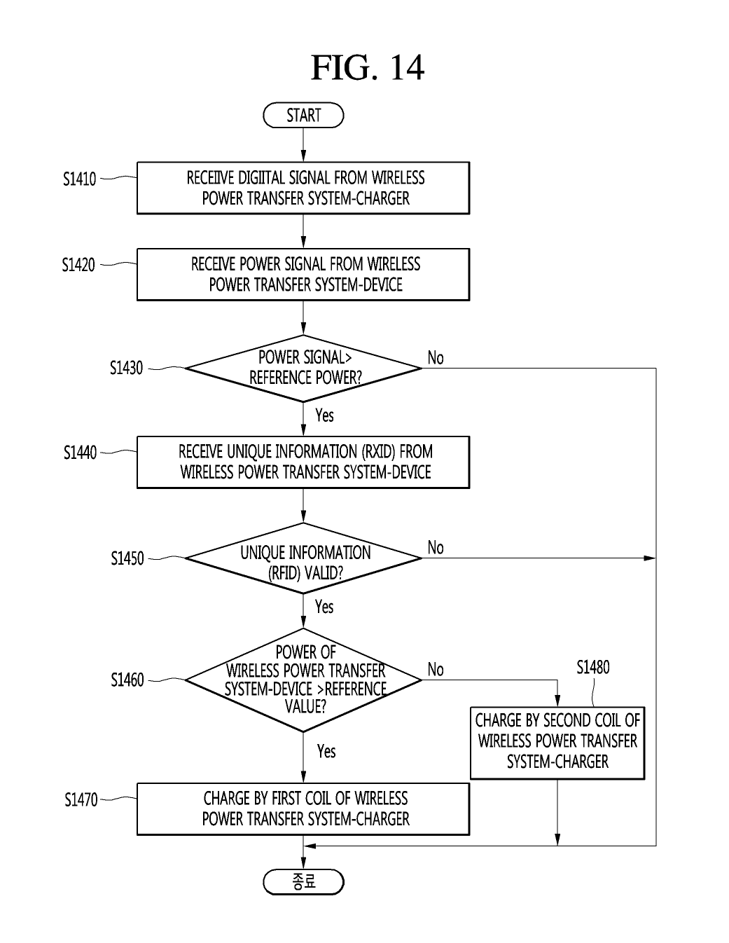

The wireless power transfer system-charger 1000 may determine power of the wireless power transfer system-device 2000 based on a unique information RXID in operation S1420. The wireless power transfer system-charger 1000 may transmit power by selecting one of a plurality of transmission coils corresponding thereto based on the power of the wireless power transfer system-device 2000 in operation S1430. A concrete method of operating the wireless power transfer system-charger 1000 will be described in detail with reference to FIG. 14.

FIG. 14 is a flowchart for describing a method of operating a wireless power transfer system-charger according to yet another embodiment of the present invention.

Referring to FIG. 14, the wireless power transfer system-charger 1000 may transmit an analog signal in a standby state. When the wireless power transfer system-device 2000 is searched, the wireless power transfer system-charger 1000 transmits a digital signal to the wireless power transfer system-device 2000 in operation S1510. A frequency of a digital signal may be 285 kHz or more and 315 kHz or less. For example, the wireless power transfer system-charger 1000 may transmit five times or less of digital signals for a time period of 28 ms or less. When there is no response from the wireless power transfer system-device 2000, the wireless power transfer system-charger 1000 may return to the standby state.

The wireless power transfer system-charger 1000 may receive a power signal from the wireless power transfer system-device 2000 in operation S1520. A frequency of the power signal may be 215 kHz or more and 220 kHz or less, but is not limited thereto.

When a power signal received from the wireless power transfer system-device 2000 is valid in operation S1530, the wireless power transfer system-charger 1000 may receive a unique information RXID of the wireless power transfer system-device 2000 in operation S1540.

The wireless power transfer system-charger 1000 determines whether a unique information RXID is valid in operation S1550. When the unique information RXID is valid, power of the wireless power transfer system-device 2000 may be determined based on the unique information RXID. The determined and received power of the wireless power transfer system-device 2000 may be compared with the reference power in operation S1560. The reference power may be 5 W, but is not limited thereto.

When the power of the wireless power transfer system-device 2000 is higher than the reference power, the wireless power transfer system-charger 1000 may select the first transmission coil to transmit the power in operation S1570. When the power of the wireless power transfer system-device 2000 is lower than the reference power, the wireless power transfer system-charger 1000 may select the second transmission coil to transmit the power in operation S1580.

In the above description of the present invention, while the present invention has been particularly shown and described with reference to exemplary embodiments thereof. It will be understood by a person of ordinary skill in the art or those skilled in the art that various changes in form and details may be made therein without departing from the spirit and scope of the present invention as defined in the appended claims. Therefore, the technical scope of the present invention should not be limited to the contents described in the detailed description of the specification, but should be defined by the claims.

1. A method of operating a wireless power transfer system-charger for selecting one of a plurality of transmission coils according to a wireless power transfer system-device, the method comprising:
receiving a unique information (RXID) from the wireless power transfer system-device;
determining a size of the wireless power transfer system-device based on the unique information (RXID); and
selecting one of a plurality of transmission coils depending on the size of wireless power transfer system-device.

2. The method of claim 1, further comprising:
Transmitting, by the wireless power transfer system-charger, a digital signal; and
receiving a power signal from the wireless power transfer system-device in response to the digital signal.

3. The method of claim 2, further comprising comparing the power signal with a reference power.

4. The method of claim 1, further comprising:
determining whether the unique information (RXID) is valid; and
comparing the size of the wireless power transfer system-device with the reference value.

5. The method of claim 4, further comprising transmitting power through a first transmission coil when the size of the wireless power transfer system-device is greater than the reference value.

6. The method of claim 4, further comprising transmitting power through a second transmission coil when the size of wireless power transfer system-device is smaller than the reference value.

7. A method of operating a wireless power transfer system-charger for selecting one of a plurality of transmission coils according to a wireless power transfer system-device, the method comprising:
receiving a unique information (RXID) from the wireless power transfer system-device;
determining power of the wireless power transfer system-device based on the unique information (RXID); and
selecting one of the plurality of transmission coils according to the power of the wireless power transfer system-device.

8. The method of claim 7, further comprising:
Transmitting, by the wireless power transfer system-charger, a digital signal; and
receiving a power signal from the wireless power transfer system-device in response to the digital signal.

9. The method of claim 8, further comprising comparing the power signal with the reference power.

10. The method of claim 7, further comprising:
determining whether the unique information (RXID) is valid; and
comparing the power of the wireless power transfer system-device with the reference power.

11. The method of claim 10, further comprising transmitting the power through a first transmission coil when the power of the wireless power transfer system-device is higher than the reference power.

12. The method of claim 10, further comprising transmitting the power through a second transmission coil when the power of the wireless power transfer system-device is lower than the reference power.
